(19) United States
(12) Patent Application Publication
(10) Pub. No.: US 2026/0358128 A1
(43) Pub. Date: Nov. 12, 2026

(54) AUTONOMOUS VEHICLE CONTROL DEVICE AND METHOD

(71) Applicants: Hyundai Motor Company, Seoul (KR); Kia Corporation, Seoul (KR)

(72) Inventors: Yang Woo LEE, Hwaseong-Si (KR); Se Hyun YUN, Hwaseong-Si (KR)

(73) Assignees: Hyundai Motor Company, Seoul (KR); Kia Corporation, Seoul (KR)

(21) Appl. No.: 19/388,592

(22) Filed: Nov. 13, 2025

(30) Foreign Application Priority Data
May 8, 2025 (KR) 10-2025-0059558

(51) Int. Cl. G01C 21/30; B60W 60/00

(52) U.S. Cl. CPC G01C 21/30; B60W 60/001; B60W 2520/06; B60W 2520/10; B60W 2520/16; B60W 2552/53; B60W 2554/20; B60W 2556/40

(57) ABSTRACT

In an autonomous vehicle control device, a transciever receives map information from a map server, a sensor detects an external object of a vehicle, generates object recognition information, and collects driving data of the vehicle, and a processor compares first position information about static objects included in the object recognition information with second position information about static objects included in the map information and determine a position error for each static object, determine the position error for each static object based on vehicle driving information generated based on the vehicle driving data, generate error modeling data, and store the error modeling data in the memory, adjust a position of the static object in the map information based on the error modeling data while the vehicle is traveling, and generate a driving path of the vehicle based on the map information in which the position of the static object is adjusted.

### CROSS-REFERENCE TO RELATED APPLICATION

The present application claims priority to and the benefit of Korean Patent Application No. 10-2025-0059558, filed on May 8, 2025, the present disclosure of which is incorporated herein by reference in its entirety.

### BACKGROUND

### Field of the Present Disclosure

The present disclosure relates to an autonomous vehicle control device and method.

### Discussion of Related Art

Autonomous driving technology is designed to enable vehicles to perceive their environment, generate driving paths, and safely move by themselves. The present technology involves components such as sensor data, high-definition maps, localization, path planning, and the like.

The conventional technologies perform object recognition and localization by utilizing cameras and map information, but do not systematically analyze or model errors in sensor data. Autonomous vehicles generate driving plans simply by relying on positions of cameras and relative positions between objects, and do not consider driving conditions or distance dependencies. This limits the accuracy of map building and localization, and there is a problem in that the safety and efficiency of autonomous driving are degraded.

### BRIEF SUMMARY

Various aspects of the present disclosure is directed to providing an autonomous vehicle control device and method configured for improving the safety and efficiency of an autonomous vehicle and improving the reliability of maps and paths through accurate error determination, environment-specific modeling, and real-time application.

According to various aspects of the present disclosure, there is provided an autonomous vehicle control device including a transciever, one or more sensors, one or more processors connected to the transciever and the one or more sensors, and a memory storing one or more programs executed by the one or more processors, in which the transciever receives map information from a map server, the sensor is configured to detect an external object of a vehicle, generates object recognition information, and collects driving data of the vehicle, and the processor is configured to compare first position information related to static objects included in the object recognition information with second position information related to static objects included in the map information and determine a position error for each static object, determine the position error for each static object based on vehicle driving information generated based on the vehicle driving data and generate error modeling data and store the error modeling data in the memory, adjust a position of the static object in the map information based on the error modeling data while the vehicle is traveling, and generate a driving path of the vehicle based on the map information in which the position of the static object is adjusted.

The static object may include one or more of a driving lane, a road boundary, a stop line, a crosswalk, a road marking, and a sign.

When the static object is a driving lane or a road boundary, the processor may compare the first position information with the second position information for each segment divided at regular intervals and determine the position error for each static object.

When the static object is a stop line, a crosswalk, a road marking, or a sign, the processor may compare the second position information related to static objects including the same attribute disposed within a predetermined distance based on the first position information and determine the position error for each static object.

The processor may classify driving scenarios based on at least one of a vehicle speed, a heading angular velocity, or a pitch angle included in the vehicle driving information.

The processor may classify the position error for each static object for each driving scenario and generate the error modeling data.

The processor may be configured to normalize a distribution of the position error for each static object classified for each driving scenario and group the driving scenarios based on a similarity of the error distribution between the driving scenarios and generate the error modeling data.

The processor may be configured to divide a longitudinal distance from the vehicle to the static object at regular intervals within the grouped driving scenarios and group the position error for each static object by longitudinal distance and generate the error modeling data.

The processor is configured to determine a mean and a standard deviation of the position error for each static object by longitudinal distance and generate the error modeling data.

The processor may draw a perpendicular from a center point of the first position information to the second position information to determine a distance between the two points as the error when determining the position error for each static object.

The processor may be configured for estimating a current position of the vehicle using the position of the static object adjusted in the map information based on the error modeling data and reflect the estimated current position of the vehicle in the generation of the driving path.

According to various aspects of the present disclosure, there is provided an autonomous vehicle control method that is performed by a computing device including a transciever, one or more sensors, one or more processors connected to the transciever and the one or more sensors, and a memory storing one or more programs executed by the one or more processors, including receiving, by the transciever, map information from a map server, detecting, by the sensor, an external object of a vehicle, generating object recognition information, and collecting driving data of the vehicle, comparing, by the processor, first position information related to static objects included in the object recognition information with second position information related to static objects included in the map information and determining a position error for each static object, determining, by the processor, the position error for each static object based on vehicle driving information generated based on the vehicle driving data and generating error modeling data and storing the error modeling data in the memory, adjusting, by the processor, a position of the static object in the map information based on the error modeling data while the vehicle is traveling, and generating, by the processor, a driving path of the vehicle based on the map information in which the position of the static object is adjusted.

The determining of the position error for each static object may include comparing, when the static object is a driving lane or a road boundary, the first position information with the second position information for each segment divided at regular intervals and determining the position error for each static object.

The determining of the position error for each static object may include comparing, when the static object is a stop line, a crosswalk, a road marking, or a sign the second position information related to static objects including the same attribute positioned within a predetermined distance based on the first position information and determining the position error for each static object.

The generating and storing of the error modeling data in the memory may include classifying driving scenarios based on at least one of a vehicle speed, a heading angular velocity, or a pitch angle included in the vehicle driving information.

The generating and storing of the error modeling data in the memory may include classifying the position error for each static object for each driving scenario and generating the error modeling data.

The generating and storing of the error modeling data in the memory may include normalizing a distribution of the position error for each static object classified for each driving scenario and grouping the driving scenarios based on a similarity of the error distribution between the driving scenarios and generating the error modeling data.

The generating and storing of the error modeling data in the memory may include dividing a longitudinal distance from the vehicle to the static object at regular intervals within the grouped driving scenarios and grouping the position error for each static object by longitudinal distance and generating the error modeling data.

The generating and storing of the error modeling data in the memory may include determining a mean and a standard deviation of the position error for each static object by longitudinal distance and generating the error modeling data.

The generating of the driving path of the vehicle may include estimating a current position of the vehicle using the position of the static object adjusted in the map information based on the error modeling data; and reflecting the estimated current position of the vehicle in the generation of the driving path.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view showing a vehicle transmitting and receiving data by communicating with other devices;

FIG. 2 is a diagram showing modules forming a vehicle according to an exemplary embodiment of the present disclosure;

FIG. 3 is a diagram for describing the operation of an autonomous vehicle control device according to an exemplary embodiment of the present disclosure;

FIG. 4, FIG. 5, FIGS. 6A and 6B, FIG. 7, FIG. 8, FIG. 9, FIG. 10 and FIG. 11 are views for describing the operation of a processor according to the embodiment; and

FIG. 12 is a flowchart of a method for controlling an autonomous vehicle according to an exemplary embodiment of the present disclosure.

### DETAILED DESCRIPTION OF EXEMPLARY EMBODIMENTS

Hereinafter, exemplary embodiments of the present disclosure will be described in detail with reference to the accompanying drawings.

However, the technical idea of the present disclosure is not limited to some embodiments to be described but may be implemented in various different forms, and within the scope of the technical idea of the present disclosure, one or more among components in the embodiments may be used by being selectively combined and substituted.

Furthermore, unless specifically defined and described, terms used in the embodiments of the present disclosure (including technical and scientific terms) may be interpreted as meanings which are generally understood by those skilled in the art to which an exemplary embodiment of the present disclosure pertains, and commonly used terms such as terms defined in dictionaries may be interpreted in consideration of the contextual meaning of the related art.

The terms used in the embodiments of the present disclosure are for describing the embodiments only and are not intended to limit the present disclosure.

In the present specification, the singular forms may include the plural forms unless the context clearly dictates otherwise, and when described as “at least one (or one or more) among A, B, and (or) C,” it may include one or more of all possible combinations of A, B, and C.

Furthermore, when describing components of embodiments of the present disclosure, terms such as “first,” “second,” “A,” “B, “(a),v” (b),” etc., may be used.

These terms are only for distinguishing the components from other components, and the essence, sequence, or order of the components is not limited by these terms.

Furthermore, when a component is described as being “linked,” “coupled,” or “connected” to another component, the component is not only directly linked, coupled, or connected to another component, but also “linked,” “coupled,” or “connected” to another component with yet another component disposed between the component and the other component.

Furthermore, when a component is described as being formed or disposed “on (above) or under (below)” another component, the term “on (above) or under (below)” includes not only when two components are in direct contact with each other, but also when one or more other components are formed or disposed between the two components. Furthermore, when a component is described as being “on (above) or below (under),” the description may include the meanings of an upward direction and a downward direction based on one component.

Hereinafter, embodiments will be described in detail with reference to the accompanying drawings, but the same or corresponding components are denoted by the same reference numerals regardless of the drawing numbers, and redundant descriptions thereof will be omitted.

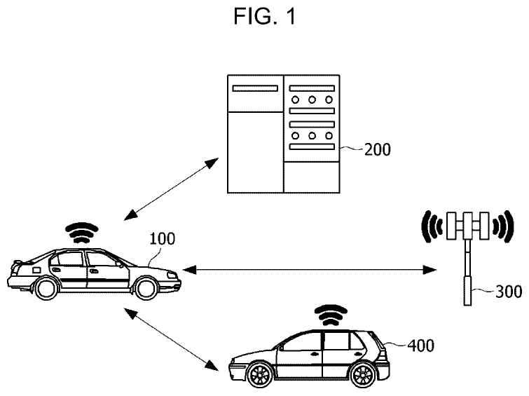

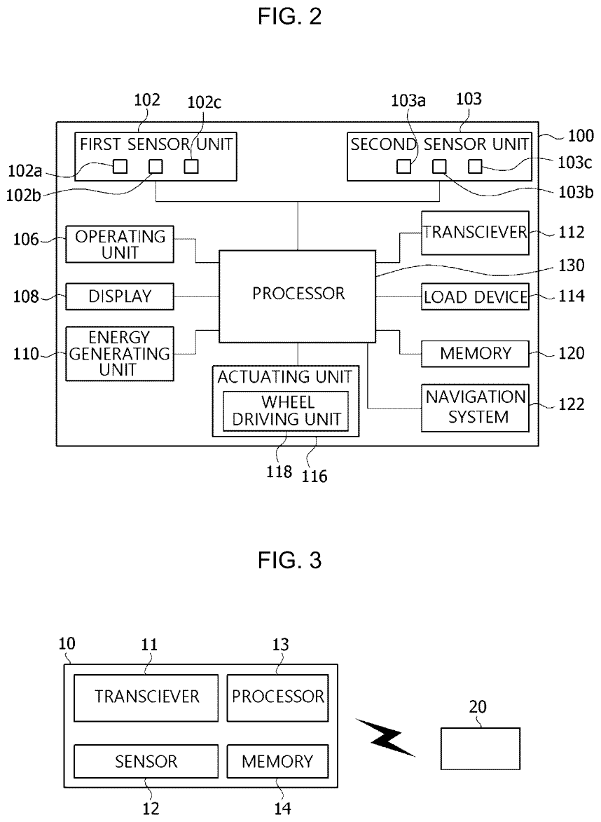

Hereinafter, a vehicle will be described with reference to FIG. 1 and FIG. 2. FIG. 1 is a view exemplarily illustrating a vehicle transmitting and receiving data by communicating with other devices.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. Furthermore, the fuel cell may use various types of gas configured for generating electrical energy, and the vehicle 100 may be filled with gas, for example, in a liquefied state. Here, one example of the gas may be hydrogen. However, the gas is not limited thereto, and various gases are applicable. In the case of a vehicle driven based on fossil energy, the vehicle 100 is driven based on fuel such as gasoline, diesel or liquefied gas, and may be disposed with an internal combustion engine that drives an actuating unit 116 by combustion of the fuel. The engine may be included in an energy generating unit 110 in terms of providing a driving rotation force of wheels to a wheel driving unit 118. As an exemplary embodiment of the present disclosure, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sports utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be a robot in a broad sense, such as a means of movement, and the robot may move using wheels, tracks, or other movement modules. In an exemplary embodiment of the present disclosure, ground mobility devices such as ground vehicles are mainly described, but unless it contradicts the present disclosure, the exemplary embodiment of the present disclosure may also be applied to air mobility devices such as an advanced air mobility (AAM), aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or disposed to service autonomous driving, and may receive connected data of the vehicle 100 or transmit data necessary for autonomous driving. The server 200 may transmit various pieces of information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a WiFi communication network, a WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the above-described embodiment.

FIG. 2 is a diagram showing modules forming a vehicle according to an exemplary embodiment of the present disclosure;

The vehicle 100 may include a sensor unit 102, an operating unit 106, a display 108, a load device 114, and a transciever 112.

The sensor unit 102 may be disposed with various types of detectors to detect various states and situations occurring in an external environment, an internal system, a user operation, and a boarding space of the vehicle 100.

The first sensor unit 102 may be disposed with an externally oriented camera 102a, a Light Detection and Ranging (LiDAR) sensor 102b, a radio detection and ranging (RADAR) sensor 102c, and the like, to recognize dynamic and static objects present outside the vehicle 100. The camera 102a may recognize an external object as an image while the vehicle 100 is in use, generate image data, and transmit the image data to the processor 130. The LiDAR sensor 102b may be configured to generate point cloud data as recognized data of the external object and transmit the point cloud data to the processor 130 to generate 3D spatial information that identifies at least a shape of the external object. To ascertain the presence of an external object and its relative distance, speed, direction, or the like, the radar sensor 102c may emit radio waves of a specific frequency around the vehicle 100 and generate radar data through radio waves reflected from the external object. In an exemplary embodiment of the present disclosure, the sensor unit is illustrated as including the LiDAR sensor 102b, but in other examples, the LiDAR sensor 102b may not be disposed.

The first sensor unit 102 may be configured to generate object recognition information based on sensing data. The object recognition information may include information on the presence or absence of an object, position information related to the object, information on a distance between the vehicle 100 and the object, and information on a relative speed between the vehicle 100 and the object. In the exemplary embodiment of the present disclosure, the external objects may be various objects related to the operation of the vehicle 100.

A second sensor unit 103 may be disposed with a positioning sensor 103a, a wheel sensor 103b, an attitude sensor 103c, and the like, to confirm its own location, speed, driving attitude, and the like. The attitude sensor 103c may include a gyro sensor, an angular velocity sensor, an acceleration sensor, or the like. The attitude sensor may be an inertial measurement unit (IMU) sensor and may be disposed with a 3-axis accelerometer and a 3-axis gyroscope. The attitude sensor may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may be configured to generate vehicle driving information based on sensing data. The vehicle driving information may be information generated based on data detected by various sensors disposed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, engine temperature information, and the like.

Furthermore, the vehicle driving information may include path information. The path information may refer to information generated based on a destination input by a vehicle user through the operating unit 106. The path information may refer to information that indicates a traveling path from a current position of a host vehicle to a destination on a map when the destination has been set. When no destination is set, the path information may refer to information including a road on which the host vehicle is currently traveling and a future driving path including the road.

The operating unit 106 may be configured as a module that is controlled by the user for driving. For example, the operating unit 106 may be a steering wheel for manual driving, an automatic or manual shift transmission, an accelerator pedal, a brake pedal, or the like. The operating unit 106 may be further disposed with an interface for enabling or disabling an autonomous driving mode and selecting detailed functions requested by the user so that the user may use an autonomous driving function. To receive various requests related to autonomous driving, the operating unit 106 may be configured, for example, as a hard-type interface disposed at a predetermined position inside the vehicle 100, or as a soft-type interface that can be touched on the display 108. Depending on the specifications of the autonomous vehicle, at least one of the steering wheel, the transmission, and the pedal may be omitted. For another example, the operating unit 106 may be disposed with a module that receives a user's control request for the load device 114 in addition to driving control.

The display 108 may function as a user interface. The display 108 may output and display an operating state, a control state, path/traffic information, remaining energy amount information, content requested by the driver, or the like, of the vehicle 100 by the processor 130. Furthermore, the display 108 may be configured as a touch screen configured for detecting a driver's input to receive a driver's request to instruct the processor 130.

The load device 114 is disposed on the vehicle 100 and may be a type of non-driving electrical device not including a driving power system such as the wheel driving unit 118 or the like. The load device 114 is an auxiliary device that receives electric power from the energy generating unit 110, and may be, for example, an air conditioning system, a lighting system, a seat system, various devices disposed in the vehicle 100, or the like. In an exemplary embodiment of the present disclosure, a cooling/heating system that cools or heats at least one of a battery, a fuel cell, an internal combustion engine, an air conditioning system, and a specific part of the vehicle 100 may be further included.

The transciever 112 may support mutual communication with the server 200, the ITS device 300, nearby vehicles 300, and the like. The transciever 112 may include a module that processes, for example, cellular communication, WAVE, DSRC communication, and the like. In an exemplary embodiment of the present disclosure, the transciever 112 may transmit data generated or stored while driving to the server 200 and receive data and software modules transmitted from the server 200. The transciever 112 may support communication with an electronic device carried by an occupant inside the vehicle 100. In an exemplary embodiment of the present disclosure, the vehicle 100 may transmit and receive data utilized in a method according to an exemplary embodiment of the present disclosure to or from the outside thereof through the transciever 112.

For example, the transciever 112 may receive traffic signal information from a traffic signal controller and provide the traffic signal information to the processor 130. Furthermore, the transciever 112 may receive a control signal from the traffic signal controller and provide the control signal to the processor 130.

Furthermore, the vehicle 100 may include the energy generating unit 110 and the actuating unit 116.

The energy generating unit 110 may be configured to generate and supply driving power and electric power used in a driving power system and a non-driving power system, such as the actuating unit 116. The non-driving power system may be, for example, the sensor unit 102, the operating unit 106, the display 108, the load device 114, and the transciever 112, but is not limited thereto, and may include various components that implement sensing, interface, communication, and convenience functions, not including components directly involved in driving operations. When the vehicle 100 is driven based on electrical energy, the energy generating unit 110 may be configured as an electric battery charged from the outside thereof, or configured as a combination of an electric battery and a fuel cell that charges the electric battery. In the case of a vehicle driven based on the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as an internal combustion engine. Furthermore, when the vehicle 100 is a hybrid type, the energy generating unit 110 may be disposed as a combination of the internal combustion engine and the electric battery.

The actuating unit 116 may be disposed with at least one module that implements driving operations and perform at least one driving operation among longitudinal control such as acceleration and deceleration and lateral control such as steering, according to a user request from the operating unit 106. To perform driving operations according to a command of the processor 130 by manual operation of the user or autonomous driving, the actuating unit 116 may be disposed with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be disposed with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further include a regenerative braking function.

A navigation system 122 may provide navigation information. The navigation information may include at least one of map information, set destination information, path information according to a set destination, information on various objects on the path, lane information, and current vehicle position information.

The navigation system 122 may receive information from an external device through the transciever 112 and update previously stored information. According to the exemplary embodiment of the present disclosure, the navigation system 122 may be classified as a sub-component of the operating unit 106.

Furthermore, the vehicle 100 may include a memory 120 and the processor 130.

The memory 120 may store applications and various types of data for controlling the vehicle 100, and load applications or read and record data by a request of the processor 130.

The processor 130 may perform overall control of the vehicle 100. The processor 130 may be configured to execute applications and instructions stored in the memory 120.

FIG. 3 is a diagram for describing the operation of an autonomous vehicle control device according to an exemplary embodiment of the present disclosure. Referring to FIG. 3, an autonomous vehicle control device 10 according to the exemplary embodiment of the present disclosure may include a transciever 11, a sensor 12, a processor 13, and a memory 14.

The transciever 11 receives map data from a map server 20, and the sensor 12 may collect vehicle driving information related to the host vehicle. The transciever 11 and the sensor 12 of FIG. 3 may include the same configuration as the transciever and the second sensor unit of FIG. 2, respectively.

The transciever 11 is configured to perform communication with the external map server 20 to receive map information. Here, the map information is provided by the map server 20 and may include current position information related to the vehicle and various pieces of position information and attribute information on various events occurring on the road and road situations.

In the exemplary embodiment of the present disclosure, the map information may refer to high definition (HD) map information. The HD map measures a three-dimensional shape of a road, the locations of driving lanes, stop lines, signs, and the like in advance and records the locations as high-precision coordinates. For example, driving lanes are stored in units of segments, and stop lines are defined by their endpoints. The HD map may be used to estimate a position of the vehicle or generate a path.

The transciever 11 is connected to a cloud map server 20 of a map provider that provides map data through an application programming interface (API), and may receive map data from the corresponding map server 20 and download the map data to the navigation system. For example, the map server 20 is a server managed by an external map provider and is configured to provide the latest map data required for vehicle traveling, and the map data downloaded from the map server 20 undergoes an additional processing procedure through the processor 13.

The processor 13 is configured to perform map matching for matching the map data received from the map server 20 with an actual position of the vehicle by utilizing sensor information provided from the host vehicle. Here, the map matching is a process of accurately matching the actual position of the vehicle with a road position on the map data using location sensor information such as a satellite navigation device (Global Positioning System) of the vehicle. This ensures that the actual on-road position of the vehicle exactly matches the map data, and establishes a foundation for the accurate operation of various warning and auxiliary control functions provided by driver assistance devices of the vehicle.

The sensor 12 recognizes external objects of an autonomous vehicle to generate object recognition information and collects driving data of the host vehicle (the autonomous vehicle). The sensor 12 includes the first sensor unit and the second sensor unit of FIG. 2, and each sensor unit is responsible for detecting the external environment and internal state of the vehicle.

The first sensor unit is disposed with an externally oriented camera, a LiDAR sensor, a radar sensor, and the like, to recognize dynamic and static objects present outside the vehicle. Here, the camera provides visual data, the LiDAR sensor provides three dimensional (3D) spatial data, and the radar sensor provides distance and velocity data, and these sensors work complementarily to enable accurate object recognition. The sensor 12 analyzes collected sensing data to generate object recognition information, and the object recognition information includes the presence or absence of an object, location information related to the object (e.g., X, Y, Z coordinates), distance information between the vehicle and the object, and relative speed information between the vehicle and the object. External objects refer to various objects related to the operation of the vehicle (e.g., construction structures, other vehicles, pedestrians, and the like), and these are utilized as essential data for autonomous vehicles to adapt to the road environment and safely travel.

The second sensor unit collects sensing data from a positioning sensor, a wheel sensor, and an attitude sensor to monitor a state inside the vehicle. The positioning sensor identifies a current position of the vehicle through the Global Positioning System (GPS) or Inertial Measurement Unit (IMU), the wheel sensor measures the rotation speed of the wheels to provide speed data, and the attitude sensor is configured to detect changes in the inclination or direction of the vehicle.

The processor 13 may be configured to generate the vehicle driving information based on the collected vehicle driving data. The vehicle driving information is generated based on data collected from these various sensors, and includes vehicle attitude information (e.g., roll, pitch, yaw angle), speed information, incline information, weight information, direction information, battery information, fuel information, tire pressure information, steering information, indoor temperature information, indoor humidity information, pedal position information, engine temperature information, and the like. Such types of information reflect a dynamic state of the vehicle in real time, thereby supporting an autonomous driving algorithm in making an optimal driving determination.

In the exemplary embodiment of the present disclosure, the object recognition information includes results of identifying objects such as pedestrians, vehicles, and obstacles through a deep learning-based object detection algorithm (e.g., You Only Look Once (YOLO), Single Shot Multibox Detector (SSD), or the like).

Furthermore, the vehicle driving information includes route information. The route information is generated based on a destination entered by a vehicle user, and refers to data in which a driving route from a current location of the vehicle to a destination is shown on a high-definition map (HD Map) when the destination is set. This is determined using a path planning algorithm provided by the navigation system (e.g., the A* algorithm or Dijkstra algorithm) and reflects geographical data such as road lanes, intersections, speed limits, and the like. When the destination is not set, the route information includes a road on which the host vehicle is currently traveling and a predicted future driving route based on the road. For example, real-time sensor data and pre-learned road network data are combined to dynamically generate a route, which assists the autonomous vehicle in safely traveling even without a destination.

The processor 13 compares first position information related to static objects included in the object recognition information with second position information related to static objects included in the map information and determines a position error for each static object.

The processor 13 according to the exemplary embodiment of the present disclosure may be configured to determine the position errors of static objects and adjust the positions of the static objects on the map information. To the present end, the processor 13 compares the position of a static object recognized through the sensor with HD map data, is configured to determine an error, models the determined error, and generates error modeling data.

The processor 13 generates the error modeling data based on the object recognition information, vehicle driving information, and map information collected at a plurality of first time points. Furthermore, the processor 13 detects static objects from the object recognition information collected at second time points, and adjusts the positions of the detected static objects on the map information based on the error modeling data.

In the exemplary embodiment of the present disclosure, the second time points may refer to time points at which errors of static objects in map information are adjusted and a driving path is generated based on the adjustment to perform autonomous driving, and the first time points may refer to any number of time points prior to the second time points.

In the exemplary embodiment of the present disclosure, the static object refers to a fixed object that does not change in an autonomous driving environment, and includes one or more of a driving lane, a road boundary, a stop line, a crosswalk, a road marking, and a sign. The present static object is configured as a reference point for generating a driving path of the vehicle or estimating its position.

When the static object is a driving lane or a road boundary, the processor 13 compares the first position information with the second position information for each segment divided at regular intervals and is configured to determine the position error for each static object.

When the static object is a stop line, a crosswalk, a road marking, or a sign, the processor 13 compares the second position information related to static objects including the same attribute positioned within a predetermined distance based on the first position information and is configured to determine the position error for each static object. When determining the position error for each static object, the processor 13 draws perpendicular from the center point of the first position information to the second position information to determine a distance between the two points as the error.

The processor 13 compares the first position information related to static objects included in the object recognition information generated from the sensor with the second position information related to static objects included in the map information received from the map server through the transciever and is configured to determine the position error for each static object. Here, the first position information represents position data of static objects recognized in real time through the sensor, particularly the camera, and the second position information represents reference position data of the corresponding static object provided on the HD map. As described above, the HD map is a map that includes detailed three-dimensional information related to roads and surrounding environments, and is utilized to estimate the position of the vehicle or plan a path in autonomous driving.

When the static object is a driving lane or a road boundary, the processor 13 analyzes the driving lane or the road boundary in units of segments separated at regular intervals.

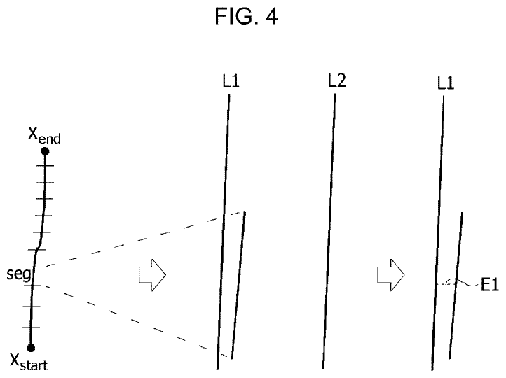

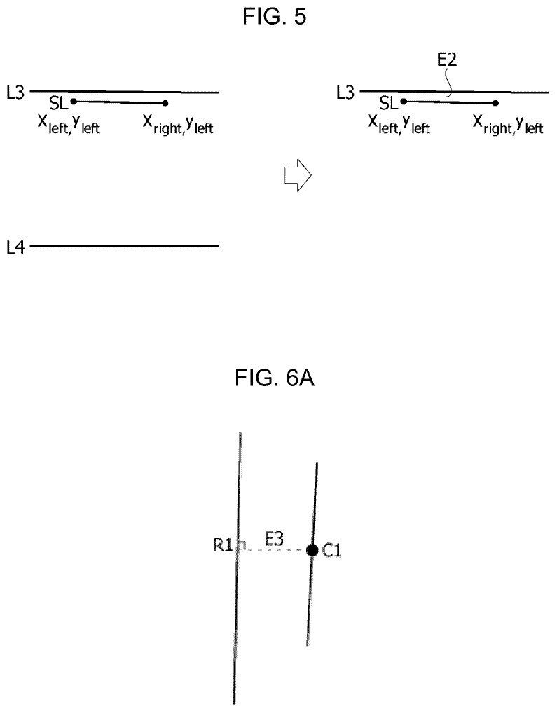

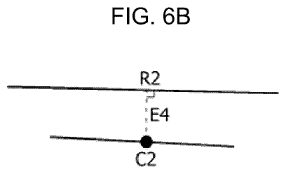

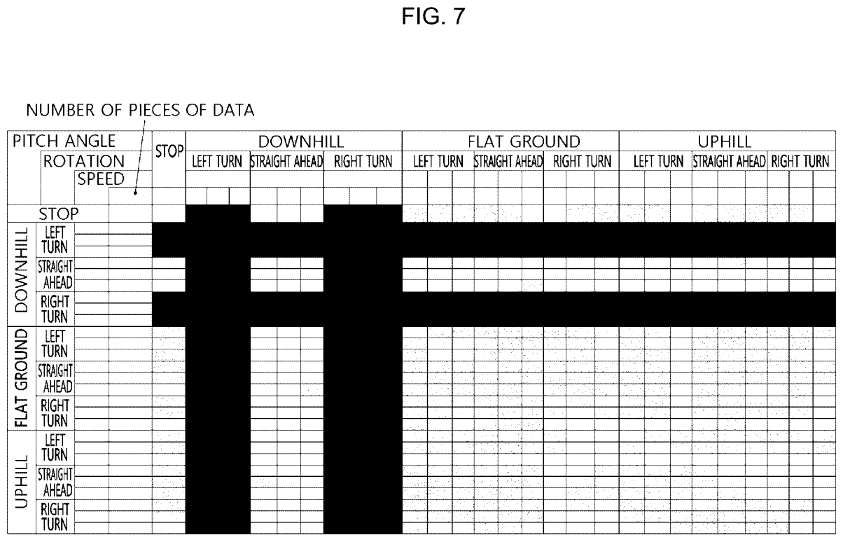

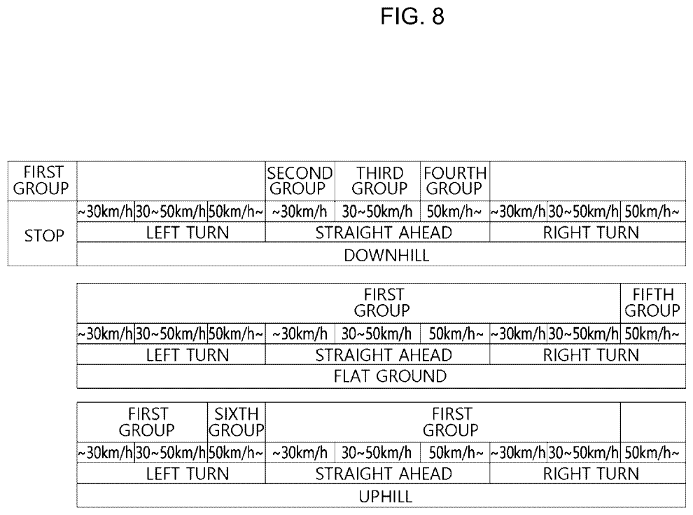

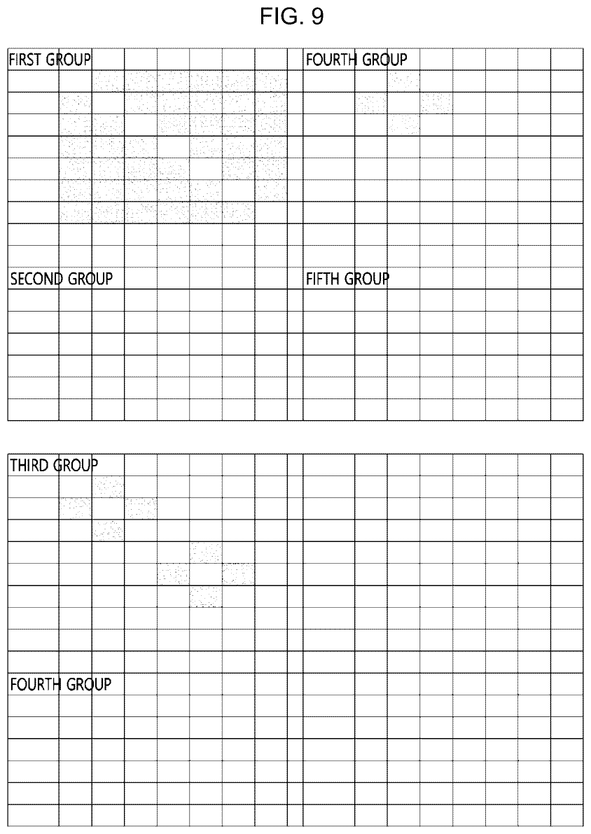

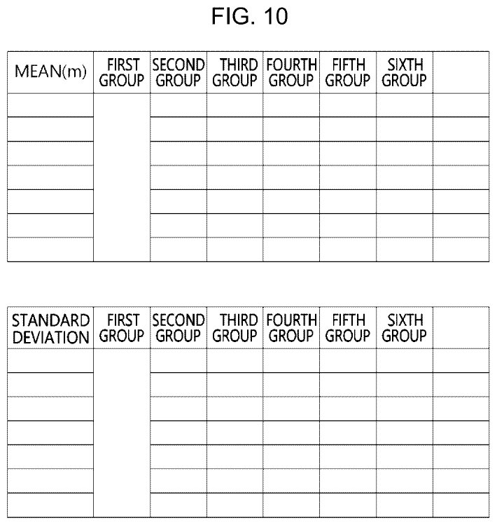

FIG. 4, FIG. 5, FIG. 6, FIG. 7, FIG. 8, FIG. 9, FIG. 10 and FIG. 11 are views for describing the operation of the processor 13 according to the exemplary embodiment of the present disclosure. First, referring to FIG. 4, the processor 13 derives a driving lane or a road boundary recognized by the camera as coefficients and start and end points of a cubic equation. For example, the shape of the driving lane is expressed by a cubic equation such as y=ax³+bx²+cx+d, where a, b, c, and d are coefficients that determine the shape of a curve, and xₛₜₐᵣₜ and x_{end} indicates the start and end points of the lane.

The processor 13 divides the present driving lane into segments Seg by cutting the driving lane at regular intervals, for example, every 2.5 meters, from the start point. The segment length may be set to various lengths considering the balance between the accuracy of error determination and computational efficiency.

To determine the position error for each segment, the processor 13 compares the first position information of the recognized driving lane segment with the second position information corresponding to the segment of the same driving lane included in the map information. In the present process, the processor 13 is configured to determine errors for one recognized segment and all lane segments L1 and L2 disposed within a predetermined range in the map information.

The processor 13 independently determines the error for each segment pair, and determines the smallest value among the determined errors as a final position error E of the corresponding segment. The processor 13 may determine a closest correspondence between the recognized lane and the actual lane through the present minimum error selection method.

Referring to FIG. 5 together, when the static object is a stop line, a crosswalk, a road marking, or a sign, the processor 13 determines the stop line or the crosswalk recognized from the camera as coordinates of a left endpoint (x_{left}, y_{left}) and a right endpoint (x_{right}, y_{right}). This reflects the characteristic that the stop line and the crosswalk are represented as straight lines. The processor 13 extracts the second position information related to static objects including the same attribute disposed within a predetermined distance based on the first position information from the map information and compares the second position information. For example, when determining the errors between the recognized stop line and stop lines in map information, the processor 13 evaluates distance differences for all stop lines within a predetermined range. The present range may be adjusted depending on environmental conditions or the resolution of the sensor. The processor 13 is configured to determine the smallest value among the determined errors as the final position error.

For road markings and signs, the processor 13 determines a direct difference between the sensor data and the HD map data. The processor 13 derives the first position information related to the road marking or the sign recognized from the camera in a form of coordinates, and defines the difference between the map information and the second position information (that is, [sensor data-HD map data]) as the error. The processor 13 is configured to determine the error through simple coordinate comparison without complex curve modeling or segment division by considering the characteristics that the road marking and the sign are represented in a form of points or small areas. For example, for signs, comparison may be made based on center point coordinates (x, y, z).

The processor 13 draws a perpendicular from the center point of the first position information to the second position information to determine the distance between the two points as the error. Referring to FIG. 6A and FIG. 6B together, the processor 13 draws a line orthogonal to the corresponding object of the map information based on center points C1 and C2 of the recognized static object to find intersection points R1 and R2. The processor 13 defines the Euclidean distance between the intersection points R1 and R2 and the center points C1 and C2 as errors E3 and E4. In the present way, the processor 13 may intuitively and objectively quantify the position difference between the sensor data and the map information.

The processor 13 is configured to determine the position error for each static object based on vehicle driving information, and generates the error modeling data and store the data in the memory 14.

Furthermore, the processor 13 classifies driving scenarios based on at least one of the vehicle speed, the heading angular velocity, or the pitch angle included in the vehicle driving information.

Furthermore, the processor 13 classifies the position error for each static object for each driving scenario and generates the error modeling data.

Furthermore, the processor 13 normalizes a distribution of the position error for each static object classified for each driving scenario, groups the driving scenarios based on a similarity of the error distribution between the driving scenarios and generates the error modeling data.

Furthermore, the processor 13 divides a longitudinal distance from the vehicle to the static object at regular intervals within the grouped driving scenarios, groups the position error for each static object by longitudinal distance, and generates the error modeling data.

Furthermore, the processor 13 is configured to determine a mean and a standard deviation of the position error for each static object by longitudinal distance and generates the error modeling data.

The processor 13 classifies driving scenarios based on at least one of the vehicle speed, the heading angular velocity, or the pitch angle included in the vehicle driving information. The driving scenario is a framework for classifying the driving state of the vehicle, where the vehicle speed represents the speed of the vehicle, the heading angular velocity represents the turning direction of the vehicle, and the pitch angle represents the vertical inclination of the vehicle. The processor 13 may classify the vehicle speed into stop (0 to 0.5 km/h), low speed (0.5 to 30 km/h), medium speed (30 to 50 km/h), and high speed (over 50 km/h).

Furthermore, the processor 13 may classify the heading angular velocity of the vehicle into straight ahead (−5 to 5 deg/s), left turn (less than-5 deg/s), and right turn (more than 5 deg/s).

Furthermore, the processor 13 may classify the pitch angle of the vehicle into flat ground (−3 to 3 deg), downhill (−3 deg or less), and uphill (3 deg or more).

Each parameter for setting the driving scenario of the vehicle is collected through the sensors of the vehicle at a plurality of first time points. For example, when the vehicle speed is 40 km/h, the heading angular velocity is 2 deg/s, and the pitch angle is 1 deg, the processor 13 classifies this as a “medium speed-straight ahead-flat ground” scenario.

The processor 13 classifies the position error for each static object for each driving scenario and generates the error modeling data. This is a process of systematically organizing the error between the first position information and the second position information related to the static object, which has been described above, according to the driving scenario. For example, the processor 13 separately classifies the error of the driving lane recognized in a “low speed-left turn-uphill” scenario and the error in a “high speed-straight ahead-flat ground” scenario. The processor 13 normalizes the distribution of the position error for each static object classified for each driving scenario, groups the driving scenarios based on a similarity of the error distribution between the driving scenarios, and generates the error modeling data. The processor 13 continuously compares the statistical characteristics of error data collected in each driving scenario through error distribution normalization.

For example, the processor 13 may apply a standard normalization process that converts error values to have a mean of 0 and a standard deviation of 1. In the present way, the processor 13 compares distribution forms of the errors. The processor 13 quantitatively determines an error distribution similarity between the two scenarios using Kullback-Leibler divergence (KL-divergence). KL-Divergence is an information theoretic indicator that measures the difference between two probability distributions, and a value closer to 0 indicates higher similarity between two distributions. Mathematically, when probability distributions P and Q are defined on the same sample space χ, KL-Divergence is expressed as

$${D}_{K L} ( P ‖ Q ) = {\sum }_{x ∈ χ} P ( x ) {log}_{b} ( \frac{P ( x )}{Q ( x )} ) .$$

This determines how much different P(x) is from Q(x) as the expected value of the log ratio, and for example, the processor 13 is configured to determine the difference between the error distribution P for the right driving lane and the error distribution Q in another scenario.

The processor 13 groups driving scenarios including similar error tendencies based on the KL-Divergence value.

For example, the processor 13 is configured to determine the KL-Divergence between each pair of scenarios for the error distribution for the right driving lane, and is configured to determine that the error tendencies are similar and groups the scenarios together when the error values are the same as or fall within a preset range. For example, the processor 13 considers scenarios in which the number of pieces of data is less than a certain number to have a low occurrence frequency and removes the scenarios.

Referring to FIG. 7 together, the processor 13 may convert the error distribution of static object error data corresponding to each driving scenario into a KL-Divergence value and organize the KL-Divergence value in a table format.

In FIG. 7, FIG. 8, FIG. 9 and FIG. 10, the KL-Divergence value of object error data may be recorded in each matrix. The processor 13 analyzes the influence of driving conditions on static object recognition and reflects that error patterns of the same static object may vary depending on the driving scenario. That is, in FIG. 7, the processor 13 classifies the same groups into the same groups, and for example, classifies the driving scenarios into the same group, for example, when the “low speed-straight ahead-flat ground” and the “medium speed-straight ahead-flat ground” show similar error distributions. This process may be equally applied to a left driving lane, right and left road boundaries, a stop line, a crosswalk, a road marking (center point x, y coordinates), and a sign (center point x, y, z coordinates). In the present way, the processor 13 may reduce the number of error models for each driving scenario, thereby increasing computational efficiency, and comprehensively manage error patterns under similar environmental conditions.

Referring to FIG. 8 together, the processor 13 classifies the driving scenarios into first, second, third, fourth, fifth and sixth groups based on the same error tendency.

The processor 13 divides a longitudinal distance from the vehicle to the static object at regular intervals within the grouped driving scenarios, groups the position error for each static object by longitudinal distance, and generates the error modeling data. The longitudinal distance refers to a distance to a static object based on a direction of travel of the vehicle. For example, the processor 13 divides the longitudinal distance into 2.5 m, 5 m, and 7.5 m within the same scenario group for the right driving lane. The processor 13 analyzes the error distribution in each distance section and determines the similarity by utilizing KL-Divergence again. For example, the processor 13 determines that sections where the error value is less than 1 have similar error tendencies, and groups the sections accordingly. The present process reflects that errors may vary with distance, for example, driving lane errors may be different at close range (2.5 m) and at long range (15 m).

The processor 13 is configured to determine the mean and the standard deviation of the position error for each static object by longitudinal distance and generates the error modeling data. For example, the processor 13 is configured to determine the mean and the standard deviation of errors of the right driving lane in a 5 m distance segment in a particular scenario group. Here, the mean represents the central tendency of the error, and the standard deviation represents the variability of the error, and the mean and the standard deviation are determined as statistical data. Referring to FIG. 9 and FIG. 10 together, the processor 13 generates a single error model for a driving scenario group indicated in gray regardless of the longitudinal distance, and generates individual error models for each distance for the other groups. The processor 13 applies the same to the left driving lane, the road boundary, the stop line, the crosswalk, the road marking, and the sign to generate the error model.

The processor 13 generates the error modeling data by utilizing the grouped driving scenarios and the error data by longitudinal distance. The error modeling data is a statistical model that may be configured to predict the position error of a static object according to the driving condition and the distance, and the processor 13 individually generates error modeling data for each static object (a driving lane, a road boundary, a stop line, a crosswalk, a road marking, or a sign). For example, the processor 13 is configured to determine the mean and the standard deviation of the errors by longitudinal distance for the right driving lane within a specific driving scenario group (e.g., “medium speed-straight ahead-flat ground”). The driving scenario group indicated by shaded regions in FIG. 9 refers to a case where the KL-Divergence value is less than 1 and the error tendency is similar, and in the instant case, the processor 13 generates a single error model regardless of the longitudinal distance. That is, when it is determined that the errors are consistent over the entire longitudinal distance section (2.5 m to 20 m) in FIG. 10, the processor 13 applies the same mean error u and standard deviation o to all distances.

On the other hand, for other driving scenario groups, the processor 13 generates a separate error model depending on the longitudinal distance. For example, in a “low speed-left turn-uphill” scenario, in the right driving lane, the errors may vary with the mean of 0.3 m and the standard deviation of 0.1 m over the 2.5 m section and the mean of 0.5 m and the standard deviation of 0.15 m over the 7.5 m section. The processor 13 is configured to determine an independent mean and standard deviation for each longitudinal distance segment, which reflects that the error is distance dependent.

The processor 13 stores the generated error modeling data in the memory 14. The processor 13 may build error modeling data in a form of a table with the type of static objects, driving scenario groups, and longitudinal distance sections as key data and the mean errors and standard deviations as values. For example, the processor 13 stores μ=0.2 m, σ=0.05 m for the key “right driving lane, medium speed-straight ahead-flat ground, 2.5 m to 5 m.” The stored error modeling data is retrieved in real time during traveling and used to adjust static object positions in map information or estimate vehicle positions. In the present process, the processor 13 may remove driving scenarios in which the number of pieces of data is less than a certain number.

The processor 13 adjusts the positions of static objects in map information based on the error modeling data while the vehicle is traveling, and generates a vehicle driving path based on the map information in which the positions of static objects are adjusted.

The processor 13 estimates the current position of the vehicle using the positions of the static objects adjusted from the map information based on the error modeling data, and reflects the estimated current position of the vehicle in the generation of the driving path.

The processor 13 retrieves the error modeling data stored in the memory 14 while the vehicle is traveling and adjusts the positions of the static objects in the map information. As described above, the error modeling data is the result of statistically analyzing and classifying the position errors of static objects (driving lanes, road boundaries, stop lines, crosswalks, road markings, and signs) according to driving scenarios and the longitudinal distances. For example, for the right driving lane, the error modeling data for the 5-meter longitudinal distance in the “medium-speed-straight ahead-flat ground” scenario includes the mean error and the standard deviation. The processor 13 utilizes the error modeling data to correct the positions of the static objects detected at second time points in the map information. The processor 13 is configured to determine an adjusted position by combining the first position information recognized from the sensor and the error modeling data.

Referring to FIG. 11 together, the processor 13 may visualize the present adjustment process and distinguish between an inaccurate map shape before errors are applied and an accurate map shape after error modeling is applied. For example, when a center point of a static object is recorded as (x_{HD}, y_{HD}) in the map information and the error modeling data provides the mean error Ax, Ay, the processor 13 is configured to determine the adjusted position as (x_{HD}+ΔX, y_{HD}+Δy).

The processor 13 dynamically performs position adjustment according to a real-time driving environment. The processor 13 is configured to determine the current driving scenario of the vehicle (e.g., the vehicle speed, the heading angular velocity, the pitch angle) based on vehicle driving information and extracts corresponding error modeling data from the memory 14. For example, when the vehicle is traveling straight ahead at 40 km/h on a flat surface, the processor 13 applies an error model corresponding to the “medium speed-straight ahead-flat ground” scenario. Furthermore, the processor is configured to determine the longitudinal distance from the vehicle to the static object and reflects the error model for the corresponding distance range (e.g., 2.5 m to 5 m). In the present process, the processor 13 corrects the difference between the first position information based on object recognition information and the second position information based on the map information using the error modeling data, and updates the adjusted positions of the static objects to the map information. The processor 13 may perform the present update so that applies the update to a temporary map layer used during traveling, rather than a manner that directly modifies the original data of the map information.

The processor 13 generates a driving path of the vehicle based on the map information in which the positions of static objects are adjusted. The processor 13 is configured to determine an optimal path of the vehicle to move from its current position to a target point.

The processor 13 generates a path that matches the actual position of the driving lane or stop line by applying the error modeling data and reflecting the adjusted static object position. For example, when the driving lane is shifted 0.5 m to the left of the road in the map information before adjustment, the path is redetermined based on the actual lane position after adjustment. The processor 13 may be configured to generate a driving path by utilizing a path planning algorithm (e.g., A* algorithm or the Dijkstra algorithm) based on the adjusted positions of static objects.

The processor 13 estimates the current position of the vehicle using the positions of the static objects adjusted from map information based on the error modeling data. The processor 13 utilizes the adjusted position of the static object as a reference point and analyzes a relative relationship with the first position information. For example, when the first position information related to the driving lane recognized by the camera is (X₁, y₁) and the adjusted position of the driving lane in the map information is (X₂, y₂), the processor 13 is configured to determine the distance and the direction between the vehicle and the driving lane and estimates the current position of the vehicle (x_{c}, y_{c}). The processor 13 may perform position estimation through geometric transformation (e.g., triangulation) or probabilistic filtering (e.g., Kalman filter).

The processor 13 reflects the estimated current position of the vehicle in the generation of the driving path. That is, the processor 13 may use the position of the vehicle estimated through the adjusted position of the static object as a start point of path planning. For example, when the vehicle is estimated to be 2 m in front of the stop line, the processor 13 is configured to perform a stop-and-departure operation or generates a right-turn path based on the estimated vehicle location. Driving path generation may be repeatedly performed in real time.

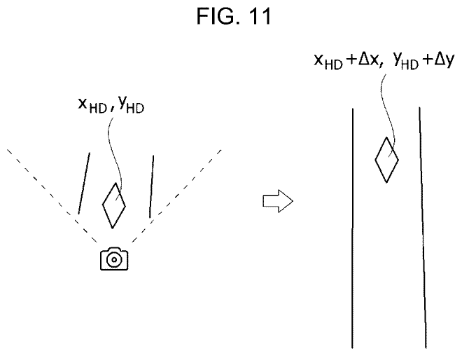

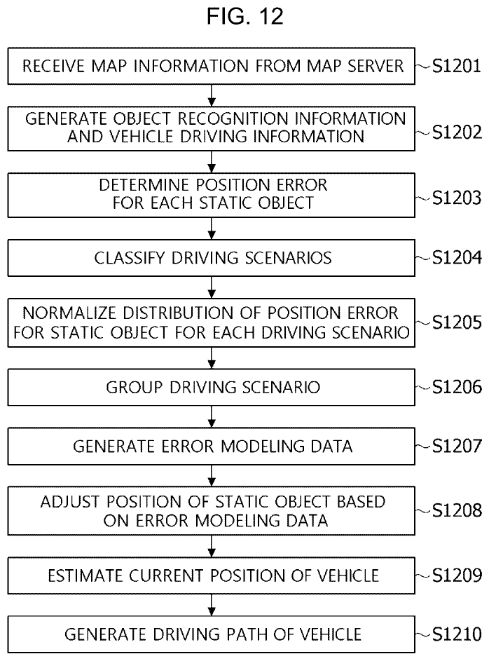

FIG. 12 is a flowchart of a method for controlling an autonomous vehicle according to an exemplary embodiment of the present disclosure.

Referring to FIG. 12, the transciever receives map information from the map server (S1201).

Subsequently or concurrently, the sensor is configured to detect an external object of the vehicle, generates object recognition information, and collects driving data of the vehicle (S1202).

Accordingly, the processor is configured to compare first position information related to static objects included in the object recognition information with second position information related to static objects included in the map information and is configured to determine a position error for each static object (S1203).

Accordingly, the processor classifies driving scenarios based on at least one of a vehicle speed, a heading angular velocity, or a pitch angle included in vehicle driving information generated based on vehicle driving data (S1204).

Accordingly, the processor normalizes the distribution of the position error for each static object classified for each driving scenario (S1205).

Accordingly, the processor groups the driving scenarios based on the similarity of the error distribution between the driving scenarios (S1206).

Accordingly, the processor divides a longitudinal distance from the vehicle to the static object at regular intervals within the grouped driving scenarios, groups the position error for each static object by longitudinal distance, and generates error modeling data (S1208).

Accordingly, the processor is configured to adjust positions of static objects in the map information based on the error modeling data while the vehicle is traveling (S1208).

Accordingly, the processor is configured for estimating the current position of the vehicle using the adjusted positions of the static objects (S1209).

Accordingly, the processor is configured to generate a driving path of the vehicle based on map information reflecting the estimated current position of the vehicle and the adjusted positions of the objects (S1210).

The term “~unit” used in an exemplary embodiment of the present disclosure refers to software components or hardware components such as a field-programmable gate array (FPGA) or an application specific integrated circuit (ASIC), and “~unit” performs certain functions. However, the “~unit” is not limited to software or hardware. The “~unit” may be configured to reside in an addressable storage medium, or may be configured to reproduce one or more processors. Therefore, for example, “~unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “~unit” may be combined into smaller numbers of components and “~units,” or may be further divided into additional components and “~units.” Furthermore, the components and “~units” may be implemented to reproduce one or more CPUs in a device or a security multimedia card.

With an autonomous vehicle control device and method according to an exemplary embodiment of the present disclosure, it is possible to accurately determine position errors of static objects, thereby improving the accuracy of map information.

Furthermore, it is possible to generate error modeling data by considering driving scenarios and longitudinal distances, thereby enhancing the environmental adaptability of an autonomous vehicle.

Furthermore, it is possible to adjust positions of static objects by applying error modeling data in real time and generate driving paths based on the adjustment.

Furthermore, it is possible to estimate a current position of a vehicle using adjusted static object positions and reflect the estimated current position in a driving path.

Furthermore, it is possible to reduce real-time computational load and improve the response speed of an autonomous driving system.

Although the exemplary embodiments of the present disclosure have been described above, it is understood that those skilled in the art can make various changes and modifications to the present disclosure without departing from the spirit and scope of the present disclosure set forth in the claims below.

What is claimed is:

1. An autonomous vehicle control device comprising:
a transciever;
one or more sensors;
one or more processors connected to the transciever and the one or more sensors; and
a memory storing one or more programs executed by the one or more processors, wherein the transciever receives map information from a map server,
wherein the one or more sensors detect an external object of a vehicle, generate object recognition information, and collect driving data of the vehicle, and wherein the one or more processors
compare first position information related to static objects included in the object recognition information with second position information related to static objects included in the map information and determine a position error for each static object;
determine the position error for each static object based on vehicle driving information generated based on the vehicle driving data, and generate error modeling data, and store the error modeling data in the memory;
adjust a position of the static object in the map information based on the error modeling data of the vehicle; and
generate a driving path of the vehicle based on the map information in which the position of the static object is adjusted.

2. The autonomous vehicle control device of claim 1, wherein the static object includes one or more of a driving lane, a road boundary, a stop line, a crosswalk, a road marking, and a sign.

3. The autonomous vehicle control device of claim 1, wherein based on that the static object is a driving lane or a road boundary, the one or more processors compare the first position information with the second position information for each segment divided at regular intervals and determine the position error for each static object.

4. The autonomous vehicle control device of claim 1, wherein based on that the static object is a stop line, a crosswalk, a road marking, or a sign, the one or more processors compare the second position information related to static objects including the same attribute disposed within a predetermined distance based on the first position information and determine the position error for each static object.

5. The autonomous vehicle control device of claim 1, wherein the one or more processors classify driving scenarios based on at least one of a vehicle speed, a heading angular velocity, or a pitch angle included in the vehicle driving information.

6. The autonomous vehicle control device of claim 4, wherein the one or more processors classify the position error for each static object for each driving scenario and generate the error modeling data.

7. The autonomous vehicle control device of claim 6, wherein the one or more processors:
normalize a distribution of the position error for each static object classified for each driving scenario; and
group the driving scenarios based on a similarity of the error distribution between the driving scenarios and generate the error modeling data.

8. The autonomous vehicle control device of claim 7, wherein the one or more processors:
divide a longitudinal distance from the vehicle to the static object at regular intervals within the grouped driving scenarios; and
group the position error for each static object by longitudinal distance and generate the error modeling data.

9. The autonomous vehicle control device of claim 6, wherein the one or more processors determine a mean and a standard deviation of the position error for each static object by longitudinal distance and generate the error modeling data.

10. The autonomous vehicle control device of claim 1, wherein the one or more processors draw a perpendicular from a center point of the first position information to the second position information to determine a distance between two points as the error when determining the position error for each static object.

11. The autonomous vehicle control device of claim 1, wherein the one or more processors:
determine a current position of the vehicle using the position of the static object adjusted in the map information based on the error modeling data; and
determine the driving path based on the estimated current position of the vehicle.

12. An autonomous vehicle control method that is performed by a computing device including a transciever, one or more sensors, one or more processors connected to the transciever and the one or more sensors, and a memory storing one or more programs executed by the one or more processors, the method comprising:
receiving, by the transciever, map information from a map server;
detecting, by the one or more sensors, an external object of a vehicle, generating object recognition information, and collecting driving data of the vehicle;
comparing, by the one or more processors, first position information related to static objects included in the object recognition information with second position information related to static objects included in the map information and determining a position error for each static object;
determining, by the one or more processors, the position error for each static object based on vehicle driving information generated based on the vehicle driving data, and generating error modeling data and storing the error modeling data in the memory;
adjusting, by the one or more processors, a position of the static object in the map information based on the error modeling data of the vehicle; and
generating, by the one or more processors, a driving path of the vehicle based on the map information in which the position of the static object is adjusted.

13. The autonomous vehicle control method of claim 12, wherein the determining of the position error for each static object includes comparing, based on that the static object is a driving lane or a road boundary, the first position information with the second position information for each segment divided at regular intervals and determining the position error for each static object.

14. The autonomous vehicle control method of claim 12, wherein the determining of the position error for each static object includes comparing, based on that the static object is a stop line, a crosswalk, a road marking, or a sign, the second position information related to static objects including the same attribute disposed within a predetermined distance based on the first position information and determining the position error for each static object.

15. The autonomous vehicle control method of claim 12, wherein the generating and the storing of the error modeling data in the memory include classifying driving scenarios based on at least one of a vehicle speed, a heading angular velocity, or a pitch angle included in the vehicle driving information.

16. The autonomous vehicle control method of claim 15, wherein the generating and the storing of the error modeling data in the memory include classifying the position error for each static object for each driving scenario and generating the error modeling data.

17. The autonomous vehicle control method of claim 16, wherein the generating and the storing of the error modeling data in the memory include:
normalizing a distribution of the position error for each static object classified for each driving scenario; and
grouping the driving scenarios based on a similarity of the error distribution between the driving scenarios and generating the error modeling data.

18. The autonomous vehicle control method of claim 17, wherein the generating and the storing of the error modeling data in the memory include:
dividing a longitudinal distance from the vehicle to the static object at regular intervals within the grouped driving scenarios; and
grouping the position error for each static object by longitudinal distance and generating the error modeling data.

19. The autonomous vehicle control method of claim 16, wherein the generating and the storing of the error modeling data in the memory include determining a mean and a standard deviation of the position error for each static object by longitudinal distance and generating the error modeling data.

20. The autonomous vehicle control method of claim 12, wherein the generating of the driving path of the vehicle includes:
determining a current position of the vehicle using the position of the static object adjusted in the map information based on the error modeling data; and
determining the driving path based on the estimated current position of the vehicle.
